(19) United States
(12) Patent Application Publication
(10) Pub. No.: US 2023/0306928 A1
(43) Pub. Date: Sep. 28, 2023

(54) DISPLAY DEVICE AND OPERATING METHOD THEREFOR

(71) Applicant: SAMSUNG ELECTRONICS CO., LTD., Suwon-si (KR)

(72) Inventor: Daesung Lim, Suwon-si (KR)

(73) Assignee: SAMSUNG ELECTRONICS CO., LTD., Suwon-si (KR)

(21) Appl. No.: 18/143,348

(22) Filed: May 4, 2023

Related U.S. Application Data
(63) Continuation of application No. PCT/KR2021/015193, filed on Oct. 27, 2021.

(30) Foreign Application Priority Data
Dec. 9, 2020 (KR) 10-2020-0171374

(51) Int. Cl. G09G 5/22

(52) U.S. Cl. CPC G09G 5/227; G09G 2340/0435

(57) ABSTRACT

A display device includes a content receiver receiving content having a first resolution, a display panel being drivable at a first frame rate with respect to the first resolution, a memory storing one or more instructions, and a processor configured to execute the one or more instructions stored in the memory to adjust a resolution of the content to a second resolution, adjust a size of graphics such that the graphics generated to correspond to the first resolution corresponds to the second resolution, synthesize the content having the second resolution and graphics having an adjusted size, and control the display panel to display a synthesized image at a second frame rate that is greater than the first frame rate.

### CROSS-REFERENCE TO RELATED APPLICATIONS

This application is a bypass continuation application of International Patent Application No. PCT/KR2021/015193, filed on Oct. 27, 2021, which is based on and claims priority to Korean Patent Application No. 10-2020-0171374, filed on Dec. 9, 2020 in the Korean Intellectual Property Office, the disclosures of each of which are incorporated by reference herein in their entireties.

### BACKGROUND

### 1. Field

Various embodiments relate to display devices and operating methods thereof, and more particularly, to display devices and operating methods thereof, by which content and graphics may be processed and displayed.

### 2. Description of Related Art

With the recent development of electronic technology, various types of display devices have been developed and distributed, and the number of display devices supporting super high resolutions, such as a 4 K resolution, an 8 K resolution, and the like, have been increased.

Furthermore, with the development of video equipment, high quality contents have been produced. In particular, contents with a frame rate of 120 Hz or more have recently been produced. To stably reproduce content having a 120 Hz frame rate, the operating frequency of a display device is also 120 Hz or more. However, most display devices according to the related art often have an operating frequency of 60 Hz or less. Accordingly, there is a demand for a method to stably reproduce content having a frame rate of 120 Hz or more in display devices having an operating frequency of 60 Hz or less.

Furthermore, when content having a frame rate of 120 Hz or more is displayed with graphics, a method to control graphics to be displayed according to the content having a frame rate of 120 Hz or more is needed.

### SUMMARY

Various embodiments provide display devices and operating methods thereof, by which graphics may be stably output when content is displayed at a frame rate that is greater than the frame rate of a display panel.

A display device according to an embodiment includes a content receiver receiving content having a first resolution, a display panel being drivable at a first frame rate with respect to the first resolution, a memory storing one or more instructions, and a processor configured to execute the one or more instructions stored in the memory to adjust a resolution of the content to a second resolution, adjust a size of graphics such that the graphics generated to correspond to the first resolution corresponds to the second resolution, synthesize the content having the second resolution and graphics having an adjusted size, and control the display panel to display a synthesized image at a second frame rate that is greater than the first frame rate.

The processor according to an embodiment may be further configured to execute the one or more instructions to adjust a resolution of the content to the second resolution by down-scaling a vertical resolution of the content to ½, and adjust the size of the graphics by scaling a vertical size of the graphics to a ½ size of the first resolution.

According to an embodiment, the first frame rate may be any one of 50 Hz, 60 Hz, 100 Hz, and 120 Hz, and the second frame rate may be double the first frame rate.

The processor according to an embodiment may be further configured to execute the one or more instructions to identify a frame rate of the received content, and selectively operate in any one of a dual line gating mode and a normal mode, based on the frame rate of the content.

The processor according to an embodiment may be further configured to execute the one or more instructions to operate in the dual line gating mode when the frame rate of the content is greater than the first frame rate, and operate in the normal mode when the frame rate of the content is less than or equal to the first frame rate.

The second frame rate according to an embodiment may be double the first frame rate, and the processor according to an embodiment may be further configured to execute the one or more instructions to, in the dual line gating mode, down-scale a vertical resolution of the content to ½, down-scale a vertical size of the graphics to ½, and control the display panel such that the synthesized image is displayed at the second frame rate.

The display panel according to an embodiment may include a plurality of gate lines and a plurality of data lines, and in the dual line gating mode, two adjacent gate lines of the plurality of gate lines may be simultaneously driven, and each of the plurality of data lines may provide the same data to pixels arranged in the same column.

The processor according to an embodiment may be further configured to execute the one or more instructions to repeatedly display one pixel line included in the content having the resolution adjusted to the second resolution through the two adjacent gate lines.

In an operating method of a display device according to an embodiment, the display device may include a display panel drivable at a first frame rate with respect to a first resolution, and the method may include receiving content having the first resolution, adjusting a resolution of the content to a second resolution, adjusting a size of graphics such that the graphics generated to correspond to the first resolution corresponds to the second resolution, synthesizing the content having the second resolution and graphics having an adjusted size, and displaying on the display panel a synthesized image at a second frame rate that is greater than the first frame rate.

A display device according to an embodiment may stably output graphics to a display panel even when the display device operates in a dual line gating mode.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a view for explaining an operation of displaying content by a display device according to an embodiment;

FIG. 2 is a block diagram of a configuration of a display device according to an embodiment;

FIG. 3 is a view showing the structure of a display panel according to an embodiment;

FIG. 4 is a reference view for explaining a method of driving a display panel, according to an embodiment;

FIG. 5 is a view for explaining the operation of a display device according to an embodiment;

FIG. 6 is a view for explaining an example in which a display device according to an embodiment operates in a normal mode;

FIGS. 7 and 8 are views for explaining an example in which a display device according to an embodiment operates in a dual line gating mode;

FIG. 9 is a view for explaining an example in which a display device according to an embodiment operates in a dual line gating mode;

FIG. 10 is a flowchart of a method of operating a display device according to an embodiment; and

FIG. 11 is a block diagram of a configuration of a display device according to another embodiment.

### DETAILED DESCRIPTION

The terms used in the disclosure have been selected from currently widely used general terms in consideration of the functions in the disclosure. However, the terms may vary according to the intention of one of ordinary skill in the art, case precedents, and the advent of new technologies. Furthermore, for special cases, meanings of the terms selected by the applicant are described in detail herein. Accordingly, the terms used in the disclosure are defined based on their meanings in relation to the contents discussed throughout, not by their simple meanings.

When a part may “include” a certain constituent element, unless specified otherwise, it should not be construed to exclude another constituent element but may be construed to further include other constituent elements. Furthermore, terms such as “... portion,” “... unit,” “... module,” and the like stated in the disclosure may signify a unit to process at least one function or operation, and the unit may be embodied by hardware, software, or a combination of hardware and software.

The embodiments of the disclosure are described with reference to the accompanying drawings so that one skilled in the art to which the disclosure pertains can work the disclosure. However, the disclosure is not limited thereto and it will be understood that various changes in form and details may be made therein without departing from the spirit and scope of the following claims. In the drawings, a part that is not related to a description is omitted to clearly describe the disclosure and, throughout the disclosure, similar parts are referenced with similar reference numerals.

In the disclosure, the term “user” refers to a person who controls the function or operation of an image generating device using the image generating device, and may include a viewer, an administrator, or an installation engineer.

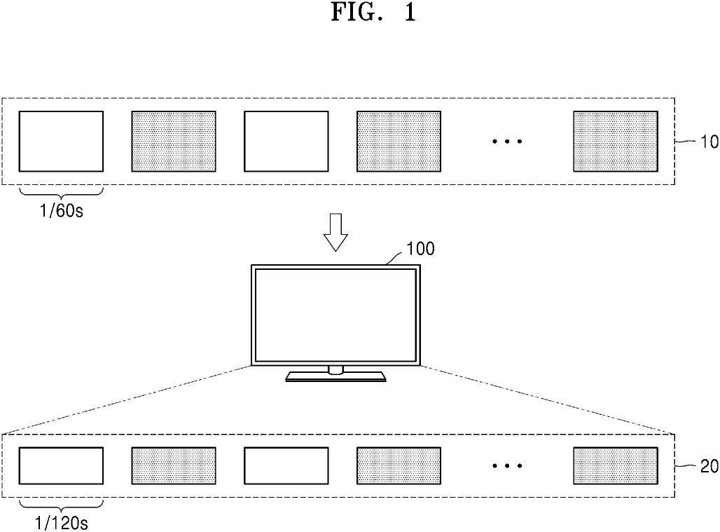

FIG. 1 is a view for explaining an operation of displaying content by a display device according to an embodiment.

Referring to FIG. 1, a display device 100 according to an embodiment is a device for displaying content. The display device 100 may be a TV, but this is only an embodiment, and the display device 100 may be implemented in various forms including a display. For example, the display device 100 may be implemented by various electronic devices, such as mobile phones, tablet PCs, digital cameras, camcorders, laptop computers, tablet PCs, desktop PCs, e-book readers, digital broadcast terminals, personal digital assistants (PDAs), portable multimedia players (PMPs), navigations, MP3 players, wearable devices, and the like. Furthermore, the display device 100 may be of a stationary type or a mobile type, and may be a digital broadcast receiver capable of receiving digital broadcast.

The display device 100 may be implemented not only by a flat display device, but also by a curved display device that is a screen having a curvature or a flexible display device with an adjustable curvature. The output resolution of the display device 100 may include for example, high definition (HD), Full HD, Ultra HD, or a resolution clearer than Ultra HD.

The display device 100 according to an embodiment may perform image-processing on input content 10, and may display the image-processed input content on a display. The input content 10 may include a plurality of frame images, and when the frame rate of the input content 10 is 120 Hz, one frame image included in the input content 10 is displayed for 1/120 s. However, assuming that the operating frequency (frame rate) of the display device 100 is 60 Hz, the display device 100 operating at 60 Hz displays one frame image for 1/60 s, and thus, some of a plurality of frame images forming 120 Hz content are omitted while the content is displayed. For example, when the number of frame images forming the input content 10 is 2n, only n frame images may be displayed among the total frame images, that is, only even-numbered frame images or odd-numbered frame images may be displayed. In this case, as some frame images are omitted, the content might not be smoothly reproduced.

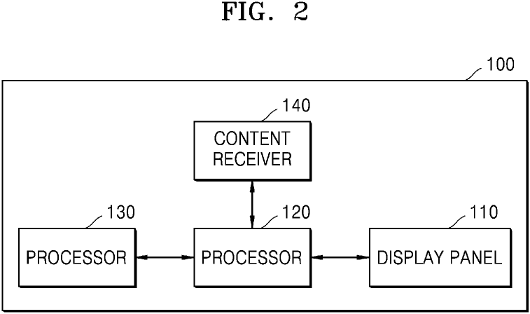

Accordingly, the display device 100 according to an embodiment may display one frame for 1/120 s, by adjusting the resolution of frame images included in the input content 10 and displaying frame images 20 with an adjusted resolution in a dual line gating mode. Accordingly, the display device 100 may stably reproduce the 120 Hz content, which will be described below in detail with reference to FIGS. 2 to 4.

FIG. 2 is a block diagram of the configuration of a display device according to an embodiment.

Referring to FIG. 2, the display device 100 according to an embodiment may include a content receiver 140, a memory 130, a processor 120, and a display panel 110.

The display panel 110 may include a plurality of pixels and display image signals. For example, when the resolution of the display panel 110 is 8K, the display panel may include 7680×4320 pixels. Alternatively, when the resolution of the display panel is 4K, the display panel may include 3840×2160 pixels. However, the disclosure is not limited thereto, and the display panel 110 may be implemented with various resolutions, and an aspect ratio thereof may be changed.

Each of a plurality of pixels in the display panel 110 may include sub-pixels representing red (R), green (G), and blue (B). However, the disclosure is not limited thereto, and each of the pixels may be implemented in various forms.

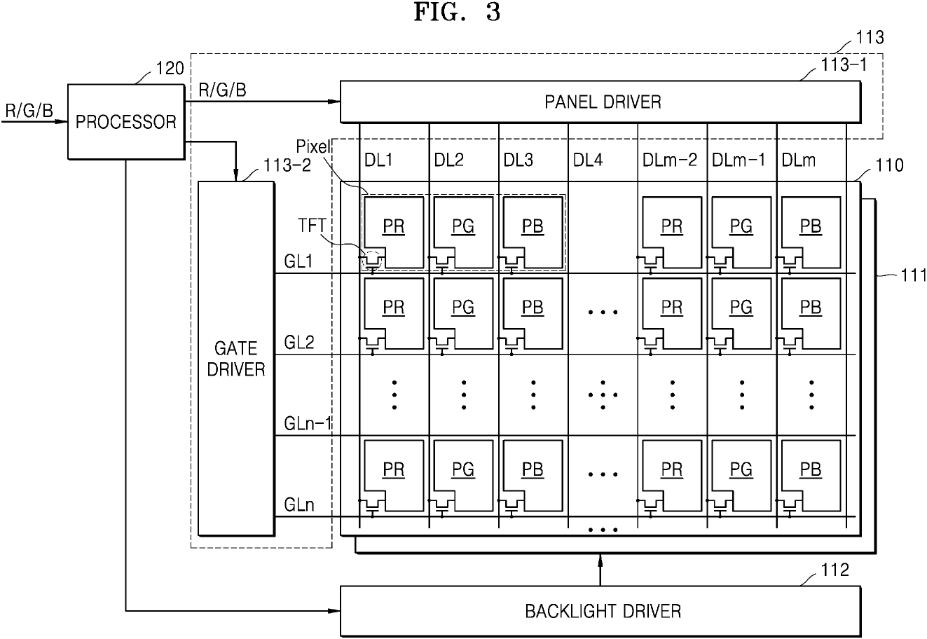

Referring to FIG. 3, the display panel 110 may include a plurality of gate lines GL1 to GLn and a plurality of data lines DL1 to DLm. The gate line is a line for transmitting a scan signal or a gate signal, and the data line is a line for transmitting a data voltage. For example, each of the pixels of the display panel 110 may be connected to one gate line and one data line. Furthermore, each of the data lines may provide data to the pixels arranged in the same column.

The display panel 110 may sequentially drive the gate lines GL1 to GLn or simultaneously drive some of the gate lines GL1 to GLn. For example, the display panel 110 may simultaneously drive two adjacent gate lines of the gate lines GL1 to GLn. Hereinafter, an operation state of sequentially driving the gate lines GL1 to GLn may be referred to as a normal mode (first operation mode), and an operation state of simultaneously driving two adjacent gate lines of a plurality of gate lines may be referred to as a dual line gating mode (second operation mode). However, the disclosure is not limited thereto, and three or more gate lines of a plurality of gate lines may be simultaneously driven.

When the display panel 110 having a first resolution operates at a first frame rate and the display panel 110 is driven in a normal mode (first operation mode), the display panel 110 may display a frame image of the first resolution at the first frame rate. In this state, the first frame rate may be 60 Hz, but the disclosure is not limited thereto. For example, the first frame rate may instead be 50 Hz, 100 Hz, or 120 Hz, among other possible frame rates.

Alternatively, when the display panel 110 is driven in a dual line gating mode (second operation mode), the display panel 110 may display a frame image of a second resolution that is less than the first resolution, at a second frame rate that is greater than the first frame rate. In this state, the second frame rate may be 120 Hz, but the disclosure is not limited thereto. For example, the second frame rate may instead be 100 Hz, 200 Hz, or 240 Hz, among other possible frame rates. In particular, the second frame rate may be double the first frame rate, although it is not limited thereto.

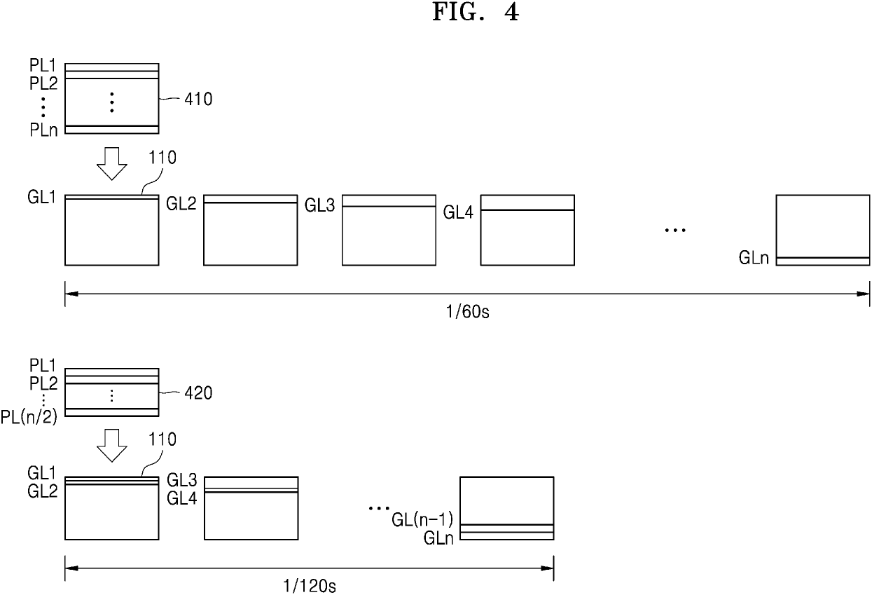

The operation of the display panel 110 is described in detail with reference to FIGS. 3 and 4 described below.

Referring back to FIG. 2, the content receiver 140 according to an embodiment may include a communication interface, an input/output interface, and the like. For example, the communication interface may transceive data or signals with an external device or a server. For example, the communication interface may include a Wi-Fi module, a Bluetooth module, an infrared communication module, a wireless communication module, a LAN module, an Ethernet module, a wired communication module, and the like. In this state, each communication module may be implemented in the form of at least one hardware chip.

The Wi-Fi module and the Bluetooth module perform communication by a Wi-Fi method and a Bluetooth method, respectively. When the Wi-Fi module or the Bluetooth module is used, various pieces of connection information, such as a service set identifier (SSID), a session key, and the like, may be first transceived, and then a communication connection may be established by using the connection information so that various pieces of information are transceived. The wireless communication module may include at least one communication chip according to various wireless communication protocols, such as Zigbee, 3rd Generation (3G), 3rd Generation Partnership Project (3GPP), Long Term Evolution (LTE), LTE Advanced (LTE-A), 4th Generation (4G), 5th Generation (5G), and the like.

Alternatively, the input/output interface may receive, from the outside of the display device 100, a video, for example, a moving picture and the like; audio, for example, voice, music, and the like; and additional information such as, for example, an electronic program guide (EPG) and the like, among other possible inputs. The input/output interface may include at least one of a High-Definition Multimedia Interface (HDMI), a Mobile High-Definition Link (MHL), a Universal Serial Bus (USB), a Display Port (DP), a Thunderbolt, a Video Graphics Array (VGA) port, an RGB port, a D-subminiature (D-SUB), a Digital Visual Interface (DVI), a component jack, a PC port, and the like.

The content receiver 140 according to an embodiment may receive content. In this state, the frame rate of the received content may be greater than the frame rate of the display panel. For example, while the frame rate of the received content may be 120 Hz, the frame rate of the display panel may be 60 Hz.

The content receiver 140 may receive variable refresh rate (VRR) content, or high frame rate (HFR) content, and the like, and the frame rate of VRR content may vary within a range of 48 Hz to 120 Hz, and the frame rate of HFR content may be 120 Hz.

The processor 120 according to an embodiment may control the overall operation of the display device 100 and the signal flow between internal constituent elements of the display device 100, and perform a function of processing data.

The processor 120 may include one or more of a single core, a dual core, a triple core, a quad core, and a multiple core thereof. Furthermore, the processor 120 may include a plurality of processors. For example, the processor 120 may be implemented by a main processor (not shown) and a sub-processor (not shown) that operates in a sleep mode.

Furthermore, the processor 120 may include at least one of a central processing unit (CPU), a graphics processing unit (GPU), and a video processing unit (VPU). Alternatively, according to an embodiment, the processor 120 may be implemented in the form of a system-on-chip (SoC) incorporating at least one of a CPU, a GPU, and a VPU.

The memory 130 according to an embodiment may store various pieces of data, programs, or applications to drive and control the display device 100.

Furthermore, the program stored in the memory 130 may include one or more instructions. The program (one or more instructions) or application stored in the memory 130 may be executed by the processor 120.

The processor 120 according to an embodiment may process video data. The processor 120 may include a video decoder for decoding video data, and may perform, on the video data, various image processing operations, such as scaling, noise filtering, frame rate conversion, resolution conversion, and the like. The processes video data may be displayed on the display panel.

Furthermore, the processor 120 may generate graphics including various objects, such as icons, images, text, and the like, by using an arithmetic unit and a rendering unit. The arithmetic unit may calculate attribute values, such as a coordinate value, a shape, a size, a color, and the like, to display each object included in graphics according to the layout of a screen, by using a user input received by the display device 100. The rendering unit may generate screens of various layouts including objects based on the attribute value calculated by the arithmetic unit. The screen generated by the rendering unit may be displayed on the display panel 110.

The processor 120 according to an embodiment may control the display panel 110 to drive in a normal mode (first operation mode) or a dual line gating mode (second operation mode). The processor 120 may drive the display panel 110 in any one of the normal mode and the dual line gating mode according to a user input. For example, when a user sets a normal mode, the processor 120 may drive the display panel 110 in the normal mode, and when a user sets a dual line gating mode, the display panel 110 may drive the display panel 110 in the dual line gating mode. Alternatively, the processor 120 may drive the display panel 110 in any one of the normal mode and the dual line gating mode, according to frame rate information of input content. For example, when input content has a frame rate that is greater than a first frame rate, the processor 120 may drive the display panel 110 in the dual line gating mode, and when the input content has a frame rate that is the same as or less than the first frame rate, the processor 120 may drive may drive the display panel 110 in the normal mode. Alternatively, when input content includes a fast movement, to improve motion blur and the like of a display, the input content may be displayed at a second resolution and a second frame rate by converting the first frame rate into the second frame rate by using a frame rate converter, and driving the display panel 110 in the dual line gating mode. However, the disclosure is not limited thereto.

The processor 120 according to an embodiment may control the display panel 110 such that, in the normal mode, frame images having the first frame rate are displayed at a first resolution and the first frame rate.

Alternatively, the processor 120 may control the display panel 110 such that, in the dual line gating mode, the resolution of frame images having the first resolution and the second frame rate is adjusted to the second resolution, and frame images having the second resolution are displayed at the second frame rate. For example, the processor 120 may adjust the resolution of frame images to the second resolution by down-scaling the vertical resolution of frame images included in the content to ½.

Furthermore, the processor 120 may, in the dual line gating mode, adjust the resolution of frame images having the first resolution and the first frame rate to the second resolution, and the frame rate thereof to the second frame rate, and display the frame images of the second resolution at the second frame rate on the display panel 110. For example, when the input frame images have the first resolution and the first frame rate, by scale-converting the resolution to the second resolution, and through the image quality processing by the frame rate converter, the frame rate is converted to the second frame rate, and thus, driving in the dual line gating mode may be possible.

Furthermore, when the resolution of frame images is adjusted, the processor 120 may, in the dual line gating mode, adjust the size of graphics generated to correspond to the adjusted resolution of frame images. For example, when the resolution of frame images is adjusted to the second resolution, by down-scaling the vertical resolution of frame images having the first resolution to ½, the processor 120 may also down-scale the vertical size of the graphics to ½.

The processor 120 may synthesize the frame images with adjusted resolution and the graphics with adjusted size, and control the synthesized frame images to be displayed on the display panel 110.

FIG. 3 is a view showing the structure of a display panel according to an embodiment.

In the display panel 110 according to an embodiment, the gate lines GL1 to GLn intersect the data lines DL1 to DLm, and R, G, and B sub-pixels PR, PG, and PB may be formed in an area where the gate lines GL1 to GLn intersect the data lines DL1 to DLm. The R, G, and B sub-pixels PR, PG, and PB adjacent to one another constitute one pixel. In other words, each pixel may include the R sub-pixel PR representing red (R), the G sub-pixel PG representing green (G), and the B sub-pixel PB representing blue (B). However, the pixel arrangement is not limited thereto, and pixels may be configured in various ways, for example, a sub-pixel representing white (W) may be further included, a sub-pixel representing another color may be further included, one or more pixel of the R, G, and B sub-pixels may be replaced with one or more sub-pixels representing other colors, or the like.

When the display panel 110 is implemented by a liquid crystal display (LCD), each of the sub-pixels PR, PG, and PB may include a pixel electrode and a common electrode, and as the orientation of liquid crystal is changed according to an electric field formed due to a potential difference between opposite electrodes, optical transmittance is changed. Thin film transistors (TFTs) formed in intersections where the gate lines GL1 to GLn intersect the data lines DL1 to DLm may provide, in response to scan pulses respectively from the gate lines GL1 to GLn, image data, that is, red R, green G, and blue B data, respectively from the data lines DL1 to DLm to the pixel electrode of each of the sub-pixels PR, PG, and PB.

The display panel 110 may further include a backlight unit 111, a backlight driver 112, and a panel driver 113.

The backlight driver 112 may be implemented in the form of including a driver IC for driving the backlight unit 111. The driver IC may be implemented by hardware separate from the processor 120. For example, when light sources included in the backlight unit 111 are implemented by LED devices, the driver IC may be implemented by at least one LED driver that controls a current applied to the LED device. The LED driver according to an embodiment is arranged in the rear end of a power supply, for example, a switching mode power supply (SMPS), and may receive a voltage from the power supply. However, according to another embodiment, a voltage may be received from a separate power unit. Alternatively, it may be possible that the SMPS and the LED driver are implemented in the form of one integrated module.

The panel driver 113 may be implemented in the form of including a driver IC for driving the display panel 110. The driver IC according to an embodiment may be implemented by hardware separate from the processor 120. For example, the panel driver 113 may include a data driver 113-1 for providing image data to the data lines DL1 to DLm and a gate driver 113-2 for providing scan pulses to the gate lines GL1 to GLn.

The data driver 113-1, which is a means for generating data signals, receives image data of R/G/B components from the processor 120 or a timing controller and generates data signals. Furthermore, the data driver 113-1 is connected to the data lines DL1 to DLm of the display panel 110 and applies the generated data signal to columns of the display panel 110.

The gate driver 113-2, which is a means for generating gate signals or scan signals, is connected to the gate lines GL1 to GLn and applies the gate signals to the columns of the display panel 110. The data signals output from the data driver 113-1 are transmitted to the pixel to which the gate signals are transmitted.

The processor 120 may simultaneously drive at least two gate lines by controlling the gate driver 113-2. For example, the processor 120, in the dual line gating mode, may simultaneously drive two adjacent gate lines. In this state, gate terminals of pixels adjacent to each other in the up and down direction are simultaneously turned on, and as the same data value is input to each of the pixels adjacent to each other in the up and down directions, the pixels may display the same color. Accordingly, in the dual line gating mode, one pixel line included in the frame images may be repeatedly displayed through two adjacent gate lines that are simultaneously driven.

FIG. 4 is a reference view for explaining a method of driving a display panel, according to an embodiment.

Referring to FIG. 4, when the display panel 110 has an 8K (7680×4320) resolution and a 60 Hz frame rate and operates in a normal mode, the display panel 110 may drive gate lines up to a 4320th gate line GLn by a method of driving a first gate line GL1 to turn on 7680 pixels corresponding to the first gate line GL1, and sequentially driving a second gate line GL2 to turn on 7680 pixels corresponding to the second gate line GL2.

For example, when the resolution of content is 8K (7680×4320), and the frame rate thereof is 60 Hz, a first frame image 410 included in the content may include 4320 pixel lines. In this state, a first pixel line PL1 may be displayed on the display panel 110 through the first gate line GL1, a second pixel line PL2 may be displayed on the display panel 110 through the second gate line GL2, and a 4320th pixel line PLn may be displayed on the display panel 110 through the 4320th gate line GLn.

As the display panel 110 sequentially scans the 4320 gate lines GL1 to GLn for 1/60 s, the first frame image 410 having a 7680×4320 resolution may be displayed on the display panel 110 having 7680×4320 pixels. Accordingly, the display panel 110 may display content at a 60 Hz frame rate.

Furthermore, when the resolution of content is 8K (7680×4320) and the frame rate thereof is 120 Hz, the display device 100 according to an embodiment may operate the display panel 110 in a dual line gating mode.

For the operation in the dual line gating mode, the resolution of content may be adjusted. For example, the display device 100 may obtain a second frame image 420 having a 7680×2160 resolution by down-scaling the vertical resolution of the first frame image 410 having a 7680×4320 resolution to ½.

The display device 100 according to an embodiment may simultaneously drive two adjacent gate lines in the dual line gating mode. For example, the display panel 110 may drive the gate lines to the 4320th gate line by a method of simultaneously driving the first gate line GL1 and the second gate line GL2 to turn on (On) 7680×2 pixels corresponding to the first gate line GL1 and the second gate line GL2, and sequentially simultaneously driving a third gate line GL3 and a fourth gate line GL4 to turn on (On) 7680×2 pixels corresponding to the third gate line GL3 and the fourth gate line GL4.

For example, the second frame image 420 includes 2160 pixel lines, the first pixel line PL1 may be displayed on the display panel through the first gate line GL1 and the second gate line GL2, the second pixel line PL2 may be displayed on the display panel through the third gate line GL3 and the fourth gate line GL4, and a 2160th pixel line PL(n/2) may be displayed on the display panel 110 through a 4319th gate line GL(n-1) and the 4320th gate line GLn.

Accordingly, the display panel 110 may display the second frame image 420 having a 7680×2160 resolution on the display panel 110 including 7680×4320 pixels, by scanning 4320 gate lines for 1/120 s.

Meanwhile, as illustrated in FIG. 4, when the display panel 110 operates in the dual line gating mode, the same pixel data is applied to the adjacent gate lines. Accordingly, one pixel line included in a frame image is repeatedly displayed through adjacent gate lines.

Meanwhile, in the dual line gating mode operation, unless the size of graphics output with a frame image is adjusted, a portion of the graphics might not be output, or graphics that do not match the frame image might be output. Accordingly, the size of the graphics may be adjusted according to the frame image with an adjusted resolution.

A method of adjusting the size of graphics by the display device 100 according to an embodiment is described below in detail with reference to the accompanying drawings.

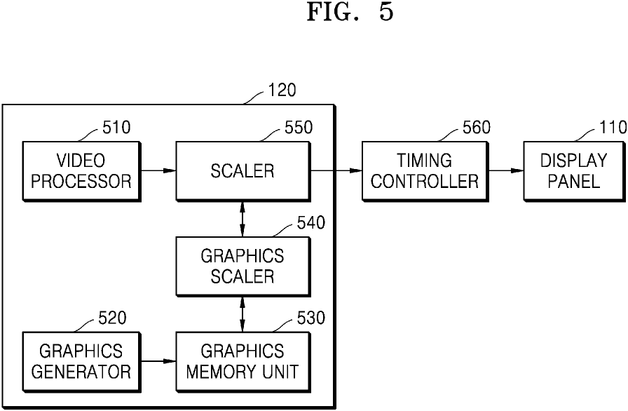

FIG. 5 is a view for explaining the operation of a display device according to an embodiment.

Referring to FIG. 5, the processor 120 according to an embodiment may include a video processor 510, a graphics generator 520, a graphics memory unit 530, a graphics scaler 540, and a mixer 550. At least one of the video processor 510, the graphics generator 520, the graphics memory unit 530, the graphics scaler 540, and the mixer 550 may be manufactured in the form of a hardware chip and mounted on the display device 100. For example, each of the video processor 510, the graphics generator 520, the graphics memory unit 530, the graphics scaler 540, and the mixer 550 may be implemented by separate hardware, or may be implemented in one chip in the form of a system-on-chip (SOC).

Alternatively, at least one of the video processor 510, the graphics generator 520, the graphics memory unit 530, the graphics scaler 540, and the mixer 550 may be implemented by a software module. When at least one of the video processor 510, the graphics generator 520, the graphics memory unit 530, the graphics scaler 540, and the mixer 550 is implemented by a software module (or a program module including instructions), the software module may be stored in a non-transitory computer-readable recording medium that can be read on a computer. Furthermore, in this case, at least one software module may be provided by an operating system (OS) or a certain application. Alternatively, a portion of at least one software module may be provided by the OS, and the other portion thereof may be provided by a certain application.

The video processor 510 according to an embodiment may perform decoding, resolution scaling, image quality processing, frame rate conversion, and the like, on the input content. For example, the video processor 510 may perform resolution scaling on content in the dual line gating mode. When the input content has an 8 K resolution and a 120 Hz frame rate, the video processor 510 may down-scale the vertical resolution to ½. However, the disclosure is not limited thereto.

The image quality processing according to an embodiment may include noise reduction, detail enhancement, contrast enhancement, block noise reduction, color control, and the like. However, the disclosure is not limited thereto.

The graphics generator 520 according to an embodiment may generate graphics to display on a screen various pieces of information as images or text, in response to a user input signal or by itself. For example, the graphics generator 520 may generate graphics including an object such as icons, images, text, and the like. The graphics generator 520 may calculate attribute values such as coordinate values, shapes, sizes, colors, and the like, to display each object included in the graphics according to the layout of a screen, by using a received user input. The graphics generator 520 may generate a screen of various layouts including an object based on the calculated attribute values. For example, the generated screen may include various pieces of data, such as a user interface screen, various menu screens, widgets, icons, and the like.

The graphics memory unit 530 according to an embodiment may store the graphics generated by the graphics generator 520 and output the stored graphics to the graphics scaler 540.

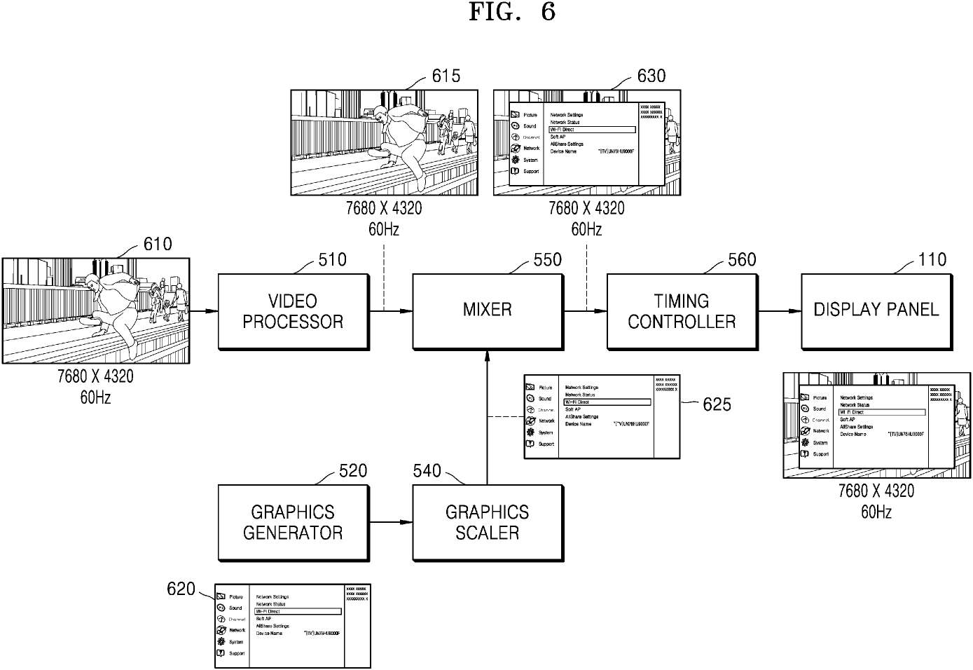

The graphics scaler 540 according to an embodiment may adjust the size of the generated graphics according to the resolution of a frame image. This will be described in detail with reference to FIGS. 6 to 8.

The mixer 550 according to an embodiment may mix the graphics and content (frame images) processed by the video processor 510.

The timing controller 560 may receive, from the processor 120, an input signal, a horizontal synchronous signal (Hsync), a vertical synchronous signal (Vsync), a main clock signal (MCLK), and the like, and generate an image data signal, a scan control signal, a data control signal, an emission control signal, and the like and provide the generated signal to the display panel 110.

Meanwhile, although FIG. 5 illustrates the timing controller 560 as a separate element from the processor 120 and the display panel 110, the timing controller 560 may be implemented as being included in the processor 120 or the display panel 110.

FIG. 6 is a view for explaining an example in which a display device according to an embodiment operates in a normal mode.

Referring to FIG. 6, the frame rate of an input content 610 according to an embodiment may be 60 Hz, and the frame rate of the display panel 110 may be 60 Hz. In this case, the display device 100 may operate in a normal mode.

The video processor 510 according to an embodiment need not additionally scale the resolution when the resolution of the input content 610 is the same as the resolution of the display panel 110. For example, when the resolution of the input content 610 and the resolution of the display panel 110 are identically 8K (7680×4320), the video processor 510 may output a frame image of an 8K (7680×4320) resolution to the mixer 550.

The graphics generator 520 may generate graphics 620. For example, the graphics generator 520 may generate graphics including various objects, such as menus, icons, images, text, and the like, and may calculate attribute values, such as a coordinate value, a shape, a size, a color, and the like, to display each object included in the graphics according to the layout of a screen output to the display device 100. In this state, the size of the graphics 620 generated by the graphics generator 520 may be the same as or less than the size of the screen displayed on the display panel.

The graphics scaler 540 may adjust the size of the graphics 620 generated by the graphics generator 520 according to the resolution of the display panel 110. When the graphics generator 520 generates graphics according to the resolution of a display panel, the size of graphics need not be additionally scaled.

The mixer 550 may generate a frame image 615 output from the video processor 510 and a synthesized frame image 630 by an alpha blending graphics 625 output from the graphics scaler 540. The resolution of the synthesized frame image 630 may be 8K (7680×4320).

The timing controller 560 may control the synthesized frame image 630 of an 8K (7680×4320) resolution to be output to the display panel 110 at 60 Hz.

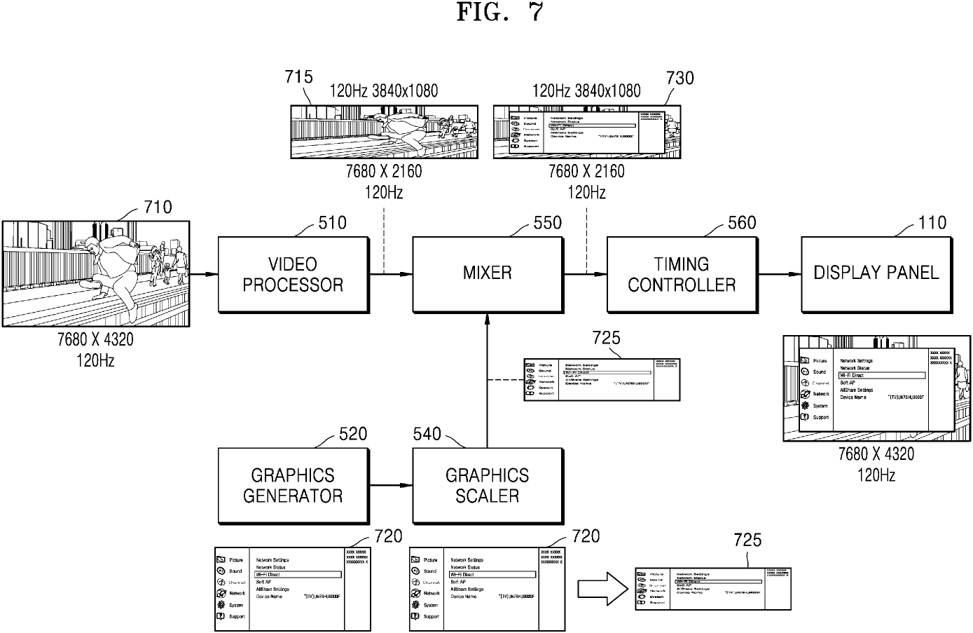

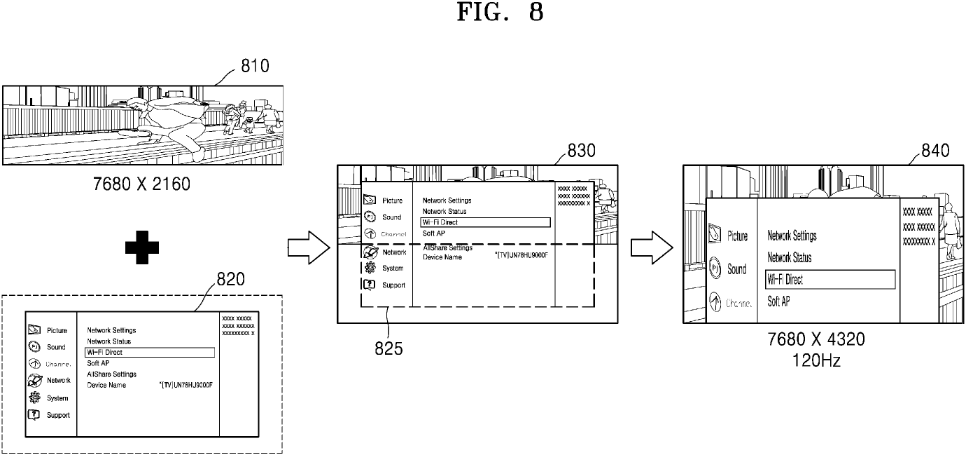

FIGS. 7 and 8 are views for explaining an example in which a display device according to an embodiment operates in a dual line gating mode.

Referring to FIG. 7, the frame rate of the input content 710 according to an embodiment may be 120 Hz, and the frame rate of the display panel 110 may be 60 Hz. The display device 100 according to an embodiment may identify frame rate information of input content, and when the frame rate of the input content is greater than the frame rate of a display panel, may automatically operate in a dual line gating mode. Alternatively, when the frame rate of input content is greater than the frame rate of a display panel, the display device 100 may display a guide message to set a dual line gating mode, and may operate in the dual line gating mode based on a user input to set the dual line gating mode. That is, the display device 100 may selectively operate in one mode or the other, according to the frame rate of the content. However, the disclosure is not limited thereto.

In the dual line gating mode operation, the video processor 510 may adjust the resolution of the input content 710. The video processor 510 may adjust the horizontal resolution or vertical resolution of frame images included in the content, based on the resolution of the display panel 110. For example, when the display panel 110 is a panel having an 8K (7680×4320) resolution, the video processor 510 may adjust the horizontal resolution of a frame image based on a horizontal resolution 7680 of the display panel 110, and the vertical resolution of the frame image based on a vertical resolution 4320 of the display panel 110. When the resolution of the input content 710 is 8K (7680×4320), the video processor 510 may perform down-scaling to make the vertical resolution of frame images 2160 while maintaining the horizontal resolution of the frame images included in the content. In other words, the resolution of the frame images may be adjusted to 7680×2160. The video processor 510 may output a frame image 715 having a 7680×2160 resolution to the mixer 550.

Furthermore, in the dual line gating mode operation, the graphics scaler 540 according to an embodiment may adjust the size of graphics 720 generated by the graphics generator 520 according to the frame image 715 having an adjusted having an adjusted resolution.

For example, FIG. 8 shows a case in which the graphics scaler 540 operates in the dual line gating mode in the same manner as in the normal mode. Referring to FIG. 8, in a case in which the vertical resolution of a frame image is scaled down to ½ so that the resolution of the frame image is adjusted to 7680×2160 while the size of graphics is not scaled, when a synthesized frame image 830 obtained by synthesizing a frame image 810 having an adjusted resolution and graphics 820 is displayed on a display panel in a dual line gating mode, a problem occurs in which a portion 825 of the graphics might not be shown in an image 840 output to the display panel.

Accordingly, in the dual line gating mode, the graphics scaler 540 may adjust the size of the graphics according to the frame image having an adjusted resolution.

For example, the graphics generator 520 may generate the graphics 720 according to the resolution of a display panel, for example, an 8K resolution. The graphics generated by the graphics generator 520 may be stored in the graphics memory unit 530.

The graphics scaler 540 may adjust the size of the graphics output from the graphics memory unit 530. The scale ratio of graphics may be set to be different according to the normal mode and the dual line gating mode, based on the size of the graphics generated by the graphics generator 520. For example, when the graphics generator 520 generates graphics according to the resolution of a display panel, the graphics scaler 540 may set the scale ratio such that, in the normal mode, the horizontal size and vertical size of the graphics are maintained, and in the dual line gating mode, the horizontal size of the graphics is maintained, and the vertical size of the graphics is scaled down to ½.

For example, the graphics scaler 540 may down-scale the vertical size of the graphics 720 generated by the graphics generator 520 to ½, and output graphics 725 having an adjusted vertical size to the mixer 550.

Furthermore, the graphics scaler 540 may increase the output frame rate of the graphics output from the graphics memory unit 530 in the dual line gating mode, double the output frame rate in the normal mode. For example, in the normal mode, graphics may be output to the graphics scaler 540 at 60 Hz according to the frame rate of a display panel, whereas in the dual line gating mode, the graphics may be output to the graphics scaler 540 at 120 Hz by doubling the frame rate.

The mixer 550 may generate a synthesized frame image 730 by alpha-blending the frame image 715 having an adjusted vertical resolution output from the video processor 510 and the graphics 725 having an adjusted vertical size output from the graphics scaler 540. In this state, the resolution of the synthesized frame image 730 may be 7680×2160.

The timing controller 560 may control such that the synthesized frame image 730 having a 7680×2160 resolution is output to the display panel 110 at 120 Hz.

For example, as two adjacent gate lines of a plurality of gate lines included in the display panel 110 are simultaneously driven, the synthesized frame image 730 may be displayed at 120 Hz. In other words, one synthesized frame image 730 may be displayed for 1/120 s. In this state, one pixel line included in the synthesized frame image 730 may be repeatedly displayed through two adjacent gate lines that are simultaneously driven. Accordingly, the display panel 110 may display the synthesized frame image 730 at an 8K (7680×4320) resolution and a 120 Hz frame rate.

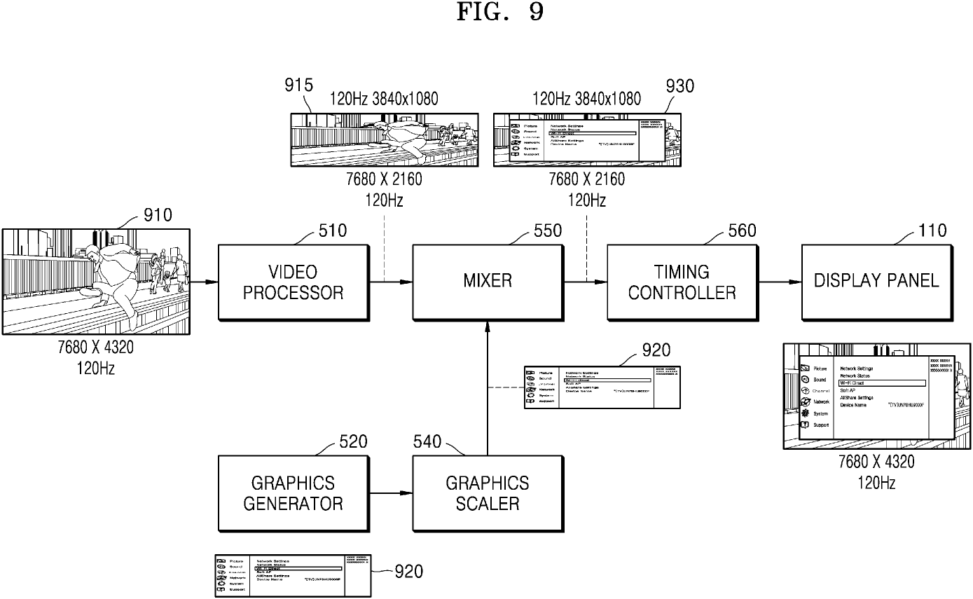

FIG. 9 is a view for explaining an example in which a display device according to an embodiment operates in a dual line gating mode.

Referring to FIG. 9, according to an embodiment the frame rate of the input content 910 may be 120 Hz, and the frame rate of the display panel 110 may be 60 Hz. The display device 100 may identify frame rate information of input content, and when the frame rate of the input content is greater than the frame rate of a display panel, may automatically operate in a dual line gating mode. In the dual line gating mode operation, the video processor 510 may adjust the resolution of an input content 910. For example, when the display panel 110 is a panel having an 8K (7680×4320) resolution and the resolution of input content is 8K (7680×4320), the video processor 510 may perform down-scaling to make the vertical resolution of frame images 2160 while maintaining the horizontal resolution of the frame images included in the content.

Meanwhile, the graphics generator 520 according to an embodiment may differently set the size of graphics generated for each of the normal mode and the dual line gating mode. For example, when, in the normal mode, graphics are set to be generated to have a first size as the horizontal size of the graphics and a second size as the vertical size thereof, in the dual line gating mode, the graphics may be set to be generated to have the first size as the horizontal size of the graphics and a third size that is ½ of the second size as the vertical size thereof.

Furthermore, when the graphics generator 520 differently sets the size of graphics generated for each of the normal mode and the dual line gating mode, the graphics scaler 540 need not additionally scale the size of graphics 920 generated by the graphics generator 520 according to a frame image 915 having an adjusted resolution.

The mixer 550 may generate a synthesized frame image 930 by alpha-blending the frame image 915 output from the video processor 510 and the graphics 920 output from the graphics scaler 540. The resolution of the synthesized frame image 930 may be 7680×2160.

The timing controller 560 may control such that the synthesized frame image 930 having a 7680×2160 resolution is output to the display panel 110 at 120 Hz. As the operation of displaying a synthesized frame image having a 7680×2160 resolution at a 120 Hz frame rate is described in detail in FIG. 7, the same description is omitted.

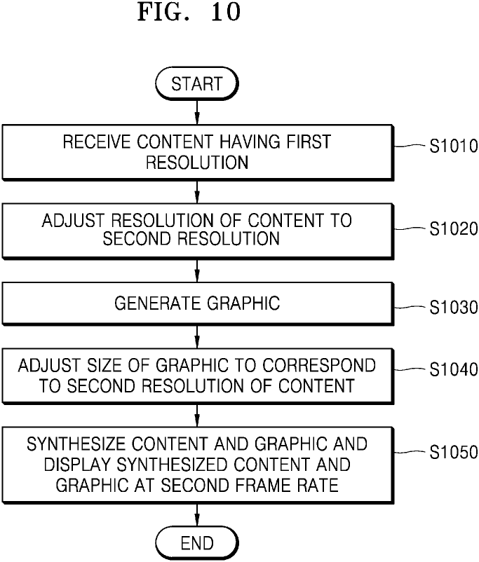

FIG. 10 is a flowchart of a method of operating a display device according to an embodiment.

Referring to FIG. 10, the display device 100 according to an embodiment may receive content (S1010). In this state, the frame rate of the received content may be greater than the frame rate of the display panel. For example, while the frame rate of the received content may be 120 Hz, the frame rate of the display panel may be 60 Hz. However, the disclosure is not limited thereto.

The display device 100 may adjust the resolution of the content to a second resolution (S1020). In this state, resolution scaling may be up scaling or down scaling. The display device 100 may adjust the horizontal resolution or vertical resolution of frame images included in the content, based on the resolution of a display panel. For example, when a display panel is a panel having an 8K (7680×4320) resolution, the display device 100 may adjust the horizontal resolution of a frame image based on a horizontal resolution 7680 of the display panel, and adjust the vertical resolution of the frame image based on a vertical resolution 4320 of the display panel.

Furthermore, the display device 100 according to an embodiment may adjust the resolution of a frame image based on the frame rate of the display panel, the frame rate of the content, and whether the driving mode of a display panel is a normal mode or a dual line gating mode.

When the frame rate of content is 60 Hz, the frame rate of a display panel is 60 Hz, and the display device 100 is driven in the normal mode, the display device 100 may adjust the resolution of frame images included in the content according to the resolution of the display panel. For example, when the resolution of a display panel is 8K (7680×4320) and the resolution of content is 8K, the display device 100 need not perform scaling on the resolution of frame images included in the content. Alternatively, when the resolution of a display panel is 8K and the resolution of content is 4K (3840×2160), the display device 100 may adjust the resolution by performing up-scaling of doubling the horizontal resolution and vertical resolution of frame images included in the content.

When the frame rate of content is 120 Hz, the frame rate of a display panel is 60 Hz, and the display device 100 is driven in the dual line gating mode, the display device 100 may adjust the resolution of frame images included in the content based on the resolution of the display panel. For example, when the resolution of a display panel is 8K (7680×4320) and the resolution of content is 8K, the display device 100 may adjust the resolution of the content to 7680×2160 by down-scaling the vertical resolution thereof to 2160 while maintaining the horizontal resolution of the frame images included in the content. Alternatively, when the resolution of a display panel is 8K and the resolution of content is 4K (3840×2160), the display device 100 may adjust the resolution of the content to 7680×2160 by up-scaling the horizontal resolution of frame images included in the content to 7680 while maintaining the vertical resolution thereof.

The display device 100 according to an embodiment may generate graphics (S1030).

For example, the display device 100 may generate graphics including various objects, such as menus, icons, images, text, and the like, and may calculate attribute values, such as a coordinate value, a shape, a size, a color, and the like, to display each object included in the graphics according to the layout of a screen output to a display panel. In this state, the size of graphics may be determined based on the resolution of the display panel.

The display device 100 may adjust the size of the graphics to correspond to the content having the second resolution adjusted in the operation S1020 (S1040).

For example, when the display device 100 operates in the dual line gating mode, the display device 100 may down-scale the vertical size of the graphics to ½ to correspond to the second resolution of the content.

The display device 100 may synthesize the frame images having an adjusted resolution and the graphics having an adjusted size, and display the synthesized frame images on the display panel at a second frame rate that is greater than the first frame rate (S1050).

The display device 100 may control such that the synthesized frame images are displayed on the display panel. In this state, the vertical resolution of the synthesized frame images may be ½ of the vertical resolution of the display panel. For example, when the resolution of a display panel is 8K (7680×4320), the resolution of the synthesized frame images may be 7680×2160. However, the disclosure is not limited thereto.

Furthermore, the display device 100 may operate the display panel in the dual line gating mode. For example, the frame rate of the display panel may be 60 Hz, the display device 100 may control such that the synthesized frame images are displayed at 120 Hz, by simultaneously driving two adjacent gate lines of a plurality of gate lines included in the display panel. In other words, one synthesized frame image may be displayed for 1/120 s. In this state, one pixel line included in the synthesized frame image may be repeatedly displayed through two adjacent gate lines that are simultaneously driven. Accordingly, a display panel having a 60 Hz frame rate may display a synthesized frame image at a 120 Hz frame rate.

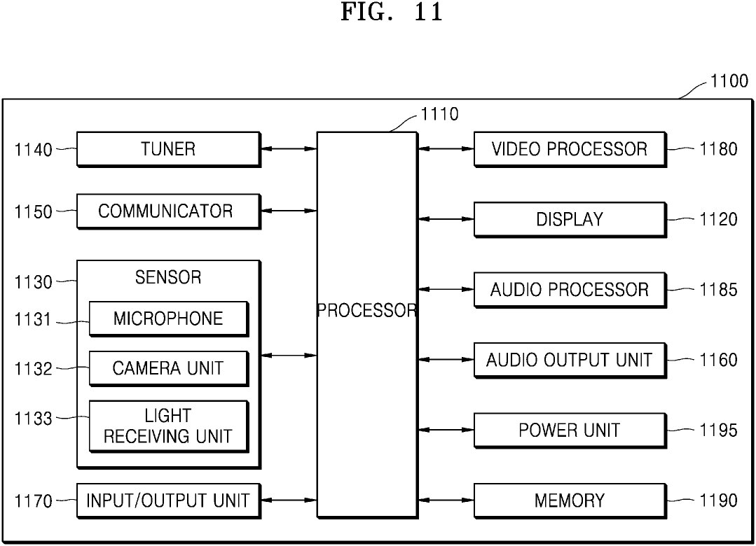

FIG. 11 is a block diagram of the configuration of a display device according to another embodiment.

Referring to FIG. 11, a display device 1100 of FIG. 11 may be an embodiment of the display device 100 described with reference to FIGS. 1 to 10.

Referring to FIG. 11, the display device 1100 according to an embodiment may include a tuner 1140, a processor 1110, a display 1120, a communicator 1150, a sensor 1130, an input/output unit 1170, a video processor 1180, an audio processor 1185, an audio output unit 1160, a memory 1190, and a power unit 1195.

The communicator 1150 of FIG. 11 corresponds to the communication interface included in the content receiver 140 described in FIG. 2, and the input/output unit 1170 of FIG. 11 corresponds to the input/output interface included in the content receiver 140 described in FIG. 2, and the processor 1110 of FIG. 11 corresponds to the processor 120 of FIG. 2, the memory 1190 of FIG. 11 corresponds to the memory 130 of FIG. 2, the display 1120 of FIG. 11 corresponds to the display panel 110 of FIG. 2, and the video processor 1180 of FIG. 11 corresponds to the video processor 510 of FIG. 5. Accordingly, the same descriptions as those described above are omitted.

The tuner 1140 according to an embodiment may tune and select only a frequency of a channel that the display device 1100 desires to receive, among many electric waves, by amplifying, mixing, resonating, and the like broadcast signals received in a wired or wireless manner. The broadcast signals may include audio, video, and additional information, for example, electronic program guide (EPG).

The tuner 1140 may receive the broadcast signals from various sources, such as terrestrial broadcast, cable broadcast, satellite broadcast, Internet broadcast, and the like. The tuner 1140 may receive the broadcast signals from sources, such as analog broadcast, digital broadcast, or the like.

The sensor 1130 may sense user’s voice, user’s image, or user’s interaction, and may include a microphone 1131, a camera unit 1132, and a light receiving unit 1133.

The microphone 1131 receives voice uttered by a user. The microphone 1131 may convert received voice to electrical signals and output the electrical signals to the processor 1110. The user’s voice may include, for example, voice corresponding to a menu or function of the display device 1100.

The camera unit 1132 may receive an image, for example, continuous frames, corresponding to a user’s motion including gesture within a camera recognition range. The processor 1110 may select a menu displayed on the display device 1100 by using a result of recognizing a received motion, or perform a control operation corresponding to the motion recognition result.

The light receiving unit 1133 receives an optical signal (including a control signal) received from an external control device through a light window (not shown) of a bezel of the display 1120, and the like. The light receiving unit 1133 may receive an optical signal corresponding to a user input, for example, touch, press, touch gesture, voice, or motion, from the control device. A control signal may be extracted from the received optical signal under the control of the processor 1110.

The input/output unit 1170 receives, under the control of the processor 1110, a video, for example, a moving picture and the like, audio, for example, voice, music, and the like, and additional information, for example, EPG and the like, and the like, from the outside of the display device 1100.

The processor 1110 controls the overall operation of the display device 1100 and a signal flow between internal constituent elements of the display device 1100, and perform a function to process data. When there is a user’s input or a preset and stored condition is satisfied, the processor 1110 may perform an operation system (OS) and various applications stored in the memory 1190.

The processor 1110 may include RAM used to store signals or data input from the outside of the display device 1100 or used as a storage area corresponding to various tasks performed in the display device 1100, ROM in which a control program for controlling an electronic device 900 is stored, and a processor.

The display 1120 generates a driving signal by converting an image signal, a data signal, an on-screen display (OSD) signal, a control signal, and the like, which are processed by the processor 1110. The display 1120 may be implemented by a plasma display panel (PDP), an LCD, an organic light-emitting diode (OLED) display, a flexible display, and the like, and furthermore, by a three-dimensional display (3D display). Furthermore, the display 1120 may include a touch screen and may be used as an input device in addition to an output device.

The audio processor 1185 may perform processing on audio data. The audio processor 1185 may perform various processes, such as decoding or amplification, noise filtering, and the like on audio data. Meanwhile, the audio processor 1185 may include a plurality of audio processing modules to process audio corresponding to a plurality of contents.

The audio output unit 1160 outputs audio including in the broadcast signals received through the tuner 1140, under the control of the processor 1110. The audio output unit 1160 may output audio, for example, voice or sound, input through the communicator 1150 or the input/output unit 1170. Furthermore, the audio output unit 1160 may output audio stored in the memory 1190, under the control of the processor 1110. The audio output unit 1160 may include at least one of a speaker, a headphone output terminal, or a Sony/Philips Digital Interface (S/PDIF) output terminal.

The power unit 1195 provides power input from an external power source to the internal constituent elements in the display device 1100, under the control of the processor 1110. Furthermore, the power unit 1195 may provide power output from one or two more batteries (not shown) located in the display device 1100 to the internal constituent elements, under the control of the processor 1110.

The memory 1190 may store various data, programs, or applications to drive and control the display device 1100, under the control of the processor 1110. The memory 1190 may include a broadcast receiving module, a channel control module, a volume control module, a communication control module, a voice recognition module, a motion recognition module, a light receiving module, a display control module, an audio control module, an external input control module, a power control module, a power control module of an external device that is connected wirelessly, for example, through Bluetooth, a voice database (DB), or a motion database (DB), which are not illustrated. The modules and data bases of the memory 1190, which are not illustrated, may be implemented by software to perform a broadcast receiving control function, a channel control function, a volume control function, a communication control function, a voice recognition function, a motion recognition function, a light receiving control function, a display control function, an audio control function, ab external input control function, a power control function, or a power control function of an external device that is connected wirelessly, for example, through Bluetooth, in the display device 1100. The processor 1110 may perform each function by using the software stored in the memory 1190.

Meanwhile, the block diagrams of the display devices 100 and 1100 illustrated in FIG. 2 and FIGS. 5 and 11 are block diagrams for an embodiment. Each constituent element of the block diagrams may be incorporated, added, or omitted according to the specifications of the display devices 100 and 1100 that are actually implemented. In other words, as necessary, two or more constituent elements may be incorporated into one constituent element, or one constituent element may be divided into two or more constituent elements. Furthermore, the function performed in each block is for describing embodiments, and a specific operation or device does not limit the scope of the disclosure.

The operating method of a display device according to an embodiment may be implemented in the form of a program command that is executable through various computer means, and recorded in a computer-readable medium. The computer-readable medium may include a program command, a data file, a data structure, and the like alone or in combination. The computer program may be specially designed and configured for the disclosure or may be well-known to one skilled in the art of computer software, to be usable. A computer-readable recording medium may include magnetic media such as hard discs, floppy discs, and magnetic tapes, optical media such as CD-ROM or DVD, magneto-optical media such as floptical disks, and hardware devices such as ROM, RAM flash memory, which are specially configured to store and execute a program command. An example of a program command may include not only machine codes created by a compiler, but also high-level programming language executable by a computer using an interpreter.

Furthermore, the display device or the operating method of the display device according to the disclosed embodiments may be provided by being included in a computer program product. A computer program product as goods may be dealt between a seller and a buyer.

A computer program product may include a S/W program or a computer-readable storage medium where the S/W program is stored. For example, a computer program product may include a product in the form of a S/W program, for example, a downloadable application, that is electronically distributed through a manufacturer of an electronic device or an electronic market For electronic distribution, at least part of a S/W program may be stored in a storage medium or temporarily generated. In this case, a storage medium may be a manufacturer’s server, an electronic market’s server, or a storage medium of a relay server that temporarily stores a SW program.

A computer program product may include a server’s storage medium or a client device’s storage medium in a system including a server and a client device. Alternatively, when there is a third device, for example, a smartphone, communicatively connected to a server or a client device, the computer program product may include a storage medium of the third device. Alternatively, a computer program product may include a S/W program that is transmitted from a server to a client device or a third device, or from the third device to the client device.

In this case, any one of a server, the client device, and the third device may perform a method according to the disclosed embodiments by executing the computer program product. Alternatively, two or more of the server, the client device, and the third device may perform, in a distribution manner, the method according to the disclosed embodiments by executing the computer program product.

For example, a server, for example, a cloud server or an artificial intelligent server, and the like, executes a computer program product stored in the server, so that the client device communicatively connected to the server may be controlled to perform the method according to the disclosed embodiments.

While the disclosure has been particularly shown and described with reference to preferred embodiments using specific terminologies, the embodiments and terminologies should be considered in descriptive sense only and not for purposes of limitation. Therefore, it will be understood by those of ordinary skill in the art that various changes in form and details may be made therein without departing from the spirit and scope of the disclosure as defined by the following claims.

What is claimed is:

1. A display device comprising:
a content receiver receiving content having a first resolution;
a display panel being drivable at a first frame rate with respect to the first resolution;
a memory storing one or more instructions; and
a processor configured to execute the one or more instructions stored in the memory to:
adjust a resolution of the content to a second resolution;
adjust a size of graphics such that the graphics generated to correspond to the first resolution correspond to the second resolution;
synthesize the content having the second resolution and graphics having an adjusted size; and
control the display panel to display a synthesized image at a second frame rate that is greater than the first frame rate.

2. The display device of claim 1, wherein the processor is further configured to execute the one or more instructions to:
adjust a resolution of the content to the second resolution by down-scaling a vertical resolution of the content to ½; and
adjust the size of the graphics by scaling a vertical size of the graphics to a ½ size of the first resolution.

3. The display device of claim 1, wherein the first frame rate is any one of 50 Hz, 60 Hz, 100 Hz, and 120 Hz, and the second frame rate is double the first frame rate.

4. The display device of claim 1, wherein the processor is further configured to execute the one or more instructions to:
identify a frame rate of the received content; and
selectively operate in any one of a dual line gating mode and a normal mode, based on the frame rate of the content.

5. The display device of claim 4, wherein the processor is further configured to execute the one or more instructions to:
operate in the dual line gating mode when the frame rate of the content is greater than the first frame rate; and
operate in the normal mode when the frame rate of the content is less than or equal to the first frame rate.

6. The display device of claim 4, wherein the second frame rate is double the first frame rate, and
wherein the processor is further configured to execute the one or more instructions to, in the dual line gating mode:
down-scale a vertical resolution of the content to ½;
down-scale a vertical size of the graphics to ½; and
control the display panel such that the synthesized image is displayed at the second frame rate.

7. The display device of claim 4, wherein the display panel comprises a plurality of gate lines and a plurality of data lines, and
wherein, in the dual line gating mode, two adjacent gate lines of the plurality of gate lines are simultaneously driven, and each of the plurality of data lines provides same data to pixels arranged in a same column.

8. The display device of claim 7, wherein the processor is further configured to execute the one or more instructions to repeatedly display one pixel line included in the content having the resolution adjusted to the second resolution through the two adjacent gate lines.

9. An operating method of a display device, the display device comprising a display panel that is drivable at a first frame rate with respect to a first resolution, the operating method comprising:
receiving content having the first resolution;
adjusting a resolution of the content to a second resolution;
adjusting a size of graphics such that the graphics generated to correspond to the first resolution corresponds to the second resolution;
synthesizing the content having the second resolution and graphics having an adjusted size; and
displaying on the display panel a synthesized image at a second frame rate that is greater than the first frame rate.

10. The operating method of claim 9, wherein the adjusting of the resolution of the content to the second resolution comprises down-scaling a vertical resolution of the content to ½, and
the adjusting of the size of the graphics comprises scaling a vertical size of the graphics to a ½ size of the first resolution.

11. The operating method of claim 9, wherein the first frame rate is any one of 50 Hz, 60 Hz, 100 Hz, and 120 Hz, and the second frame rate is double the first frame rate.

12. The operating method of claim 9, wherein the operating method further comprises:
identifying the frame rate of the received content; and
selectively setting an operation mode of the display device to any one of a dual line gating mode and a normal mode, based on a frame rate of the content.

13. The operating method of claim 12, wherein the setting of the operation mode comprises setting the operation mode to a dual line gating mode when the frame rate of the content is the second frame rate that is greater than the first frame rate, and setting the operation mode to a normal mode when the frame rate of the content is less than or equal to the first frame rate.

14. The operating method of claim 12, wherein the second frame rate is double the first frame rate, and
wherein, in the dual line gating mode:
the adjusting of the resolution of the content to the second resolution comprises down-scaling a vertical resolution of the content to ½,
the adjusting of the size of the graphics comprises down-scaling a vertical size of the graphics to ½, and
the displaying of the synthesized image on the display panel is performed at the second frame rate.

15. One or more non-transitory computer-readable recording media having stored thereon a program that, when executed by one or more processors, causes the one or more processors to perform an operating method of a display device comprising a display panel that is drivable at a first frame rate with respect to a first resolution, the operating method comprising:
receiving content having the first resolution;
adjusting a resolution of the content to a second resolution;
adjusting a size of graphics such that the graphics generated to correspond to the first resolution corresponds to the second resolution;
synthesizing the content having the second resolution and graphics having an adjusted size; and
displaying on the display panel a synthesized image at a second frame rate that is greater than the first frame rate.
